(19) United States
(12) Patent Application Publication
(10) Pub. No.: US 2013/0290219 A1
(43) Pub. Date: Oct. 31, 2013

(54) METHOD AND APPARATUS FOR COMPUTING THE RELATIVE RISK OF FINANCIAL ASSETS USING RISK-RETURN PROFILES

(71) Applicant: Donald DuBois, Redwood City, CA (US)

(72) Inventor: Donald DuBois, Redwood City, CA (US)

(21) Appl. No.: 13/928,212

(22) Filed: Jun. 26, 2013

Related U.S. Application Data
(63) Continuation-in-part of application No. 12/462,233, filed on Aug. 1, 2009.
(60) Provisional application No. 61/137,969, filed on Aug. 4, 2008.

(51) Int. Cl. G06Q 40/06

(52) U.S. Cl. CPC G06Q 40/06
USPC 705/36 R

(57) ABSTRACT

Embodiments are described for a system and method for comparing risk associated with a financial asset by creating a risk-return profile for the first asset and a risk profile for the second asset over a defined time period having a plurality of asset holding times, calculating an average negative total return of each of the first and second assets for each of the plurality of asset holding times, calculating a worst case total return of each of the first and second assets for each of the plurality of asset holding times, and calculating a percentile total return each of the first and second assets for each of the plurality of asset holding times.

### CROSS REFERENCE TO RELATED APPLICATIONS

The present application is a Continuation-in-Part of U.S. patent application Ser. No. 12/462,233, entitled “Method and Apparatus for Computing and Displaying a Risk-Return Profile as a Risk Measure for Financial Assets” and filed on Aug. 1, 2009, which in turn claims priority from provisional application Ser. No. 61/137,969 filed on Aug. 4, 2008, the entire disclosures of which are incorporated herein by reference.

### TECHNICAL FIELD

Embodiments relate generally to financial asset risk analysis and more specifically to a method and apparatus for quantifying the relative riskiness of one financial asset or index to another financial asset or index.

### BACKGROUND

Assessing the degree of risk of a financial asset is central to rational financial planning. Investors and analysts have an intuitive idea of what constitutes investment risk, but such risk is a difficult concept to define precisely so that it can be measured and quantified, and current methods generally rely on certain defined traditional metrics for quantifying the relative riskiness of financial assets.

At present, there are two standard methods for comparing the riskiness of one asset to another asset or market index within the financial industry. The first method utilizes the standard deviation statistic of asset prices and the second utilizes the Beta model of risk characterization.

With respect to the standard deviation method of quantifying the relative riskiness of assets, the formula for the standard deviation method for comparing the riskiness of one asset, asset a, to another asset or a market index (designated b) is the ratio of their individual standard deviations of monthly returns which is represented by: sₐ/s_{b}, where sₐ is the standard deviation of the total returns of asset a and s_{b} is the standard deviation of the total returns of the second asset or market index to which the first asset is being compared.

Usually the total returns are the monthly total returns and the standard period in the finance industry over which these returns are recorded is usually three years for a total of 36 total returns for each asset or index.

The formula for the standard deviation, s, is:

$$s = \sqrt{\frac{1}{N - 1} {\sum }_{i = 1}^{N} {( {x}_{i} - \overline{x} )}^{2}} ,$$

In the above equation, N is the number of observations, the xᵢ are the individual observations and the x-bar is the mean of those observations. When used in the context of comparing the riskiness of assets to other assets or an index, the observations are total returns—usually monthly total returns (either positive or negative) over a period of three years.

Despite its well-established use, the standard deviation has certain profound limitations as a risk measure. For example, the standard deviation does not distinguish between up and down price movements. By definition, the standard deviation does not distinguish between positive and negative deviations from the mean. A deviation below the mean is the same as a deviation above the mean because the deviation is squared in the standard deviation formula. However, an asset having a declining total return is generally considered more risky than an asset having an increasing total return. The inability of the standard deviation to provide a measure of the direction of the deviations from the mean is illustrated in FIG. 1. FIG. 1 illustrates the increasing asset price of an asset A and the decreasing asset price of an asset B are graphed as they change over time. Each graph has a standard deviation of 4.13 even as the price of asset A doubles from 10 to 20 and the price of asset B goes to zero.

Another case of standard deviation deficiency is the price movement of two assets, such as with one asset gaining in value by 200% and the other asset losing all its value. FIG. 2 depicts the price movements of two assets A and B, with one asset gaining in value by 200% and the other asset losing all its value. Yet, by the standard deviation method for comparing relative riskiness, the former asset's prices, the asset (A), which grew by 200% has twice the standard deviation of the other asset's prices and is therefore, by the ratio formula, assessed to be twice as risky as the asset B that lost all its value. This illustrates the inaccuracies of the standard deviation statistic in not being able to distinguish between the direction of movement of an asset's prices. By the standard deviation method for comparing relative riskiness, the former asset's prices, the one that grew by 200% has twice the standard deviation of the other asset's prices and is therefore, by the ratio formula, assessed to be twice as risky as the asset (B), which lost all its value. This indicates the inaccuracies of the standard deviation statistic in not being able to distinguish between the direction of movement of an asset's prices.

Another shortcoming of the standard deviation is that it does not record extreme price swings. By definition, standard deviation records the magnitude of deviations about the mean. This fact precludes measuring the most extreme price swings in an asset's prices over time—yet an assessment of the extremes is required for the full assessment of the degree of riskiness of an asset. A simple case of this is illustrated in FIG. 3 where the asset's mean price is 2 and the prices swing between a maximum value of 50% (3) above the mean and a minimum value of 50% (1) below the mean. It is possible that an investor would have unknowingly brought this asset when the price was at its maximum of 3 and then experienced a loss all the way to the minimum price of 1 and then sold, thinking it might have further to go down. This would have represented a total return of minus two thirds (−66.667% loss going from 3 down to 1). Nowhere in the standard deviation formula would a loss of two thirds have been recorded. The greatest deviation from the mean price, and therefore the greatest loss, would have been −50% when the price was at it's minimum. The standard deviation formula, by virtue of its definition about the mean, often understates the potential risk an investor is assuming by buying this asset, given the full range of its price swings.

Another issue is that the standard deviation smoothes out the most extreme variations in an asset's price fluctuations. The average of any set of numbers gives the central moment of those numbers. In the process, the numbers at the extreme ranges on either side of the mean are lost. Consider the following simple two number example: if there are a pair of asset total return percentages of 200% and 100%, the average of these numbers is 150%. It is also possible to have a set of two asset return figures that have a much wider variation, such as 10% and 290% whose average is also 150%. The greater variation of the second pair of return figures is lost through the averaging process.

The formula for standard deviation includes an averaging of the square of the deviations about the mean, and as such the more extreme deviations are obscured by this process. The effect of this can be seen in the graph in FIG. 4, which shows the prices of two assets over time, with one asset's price (solid line) clearly showing greater fluctuations than the asset prices represented by the dashed line. Clearly, one asset's price swings are more extreme than the second asset's prices, but the standard deviation of each set of prices is identical in both cases.

The other major risk metric used in the financial industry today, in addition to standard deviation, is the beta statistic. Beta measures the relative volatility of a financial asset as compared to an underlying benchmark that the asset is being compared to. Usually the benchmark is a representative index, to which the asset can meaningfully be compared. For example, if the asset is a U.S. equity, the representative index might be the S&P 500 index for the U.S. stock market.

With regard to the beta method of quantifying the relative riskiness of assets, the formula for the Beta of an asset, a, relative to a market index, b is:

$${β}_{a} = \frac{Cov ( {r}_{a} , {r}_{b} )}{Var ( {r}_{b} )} ,$$

In the above equation, rₐ is the total return of the asset, r_{b} the total return of the index, Cov(rₐ,r_{b}) is the covariance of the returns and Var is the variance of the index return. In the finance industry the total returns are usually monthly total returns over the most recent three year period. As stated above, beta measures the relative volatility of the asset compared to a chosen market index or relative to another asset. For example, a beta value of 1.25 for a stock compared to the S&P 500 index would mean that, on average, the returns of the stock are 25% greater than the index when the market is going up and 25% less than the market when the market index is decreasing. Similarly, if a stock's beta value is less than one at 0.80, the returns of the asset relative to the index would be plus or minus 80% of the markets returns.

Like the standard deviation, the beta measure has limitations as a risk measure. The definition of variance is standard deviation squared, thus the beta measure inherits all the limitations of standard deviation as described above because of the term in the denominator of the definition for beta. Furthermore, beta is not a meaningful statistic if there is not a good linear relationship between the monthly returns of the asset and the monthly returns of a market index or another asset to which it is being compared.

Beta is actually the slope of the straight-line approximation describing the relationship between the monthly returns of the asset and the index. One can see this in the graph of the Beta for the Fidelity Magellan mutual fund and a mutual fund that tracks the S&P 500 index (Vanguard S&P 500 Index fund), as shown in FIG. 5. In FIG. 5 the X coordinates of points in the graph record the monthly returns of the S&P 500 tracking fund and the Y coordinates track the returns of the Magellan fund. The line through the points is the linear regression line and, in this case, is a fairly good fit to the actual data points. The slope of this line is the value of Beta, which is 1.01. In other words, the Magellan fund tracks well the returns of the S&P 500 index fund. This is to be expected since the Magellan fund, as a very large domestic stock fund, owns many of the component stocks in the index, and therefore is likely to track the index fairly well.

The goodness of fit of the straight-line approximation to the data points can be measured by the R² statistic known as the coefficient of determination. In the case of a linear regression line, it is the square of the linear coefficient of variation statistic. Since the latter statistic ranges between −1.0 (perfect negative correlation) and +1.0 (perfect positive correlation) the R² statistic ranges between 0 and +1.0. A value of 1.0 means that the regression line is a perfect fit for the returns of the asset as compared to those of the index or asset to which it is being compared. A value of 0 means there is no straight-line relationship between the returns. In the case of Magellan and its comparison to the S&P 500 index fund, the R² value is 0.85, which is generally interpreted that the regression line is a fairly good fit for the points. It is generally assumed that a R² value of less than 0.50 means the regression line is not a good fit for the data and that therefore the Beta value, the slope of the line, is not a meaningful statistic. Clearly goodness of fit as measured by the R² statistic is a sliding scale from 0 to 1.0.

For beta to be a meaningful statistic, there has to be a good linear relationship between the monthly returns of the asset and those of the asset or index to which it is being compared. In many situations this is not the case. For example, it is a meaningful and important question to ask how much more or less risky is an investment in domestic bonds as compared to the domestic stock market.

A reasonable approach to answering this question is to compare the volatility of an asset which tracks the Barclay's U.S. Aggregate Bond Index to an asset which tracks the S&P 500 index. The U.S. Aggregate Bond Index measures the performance of the total U.S. investment grade bond market comprising (as of Apr. 30, 2012) 7,929 issues in the underlying index.

This beta statistic is graphed as shown in FIG. 6. FIG. 6 is the graph of the monthly total returns for an ETF (Exchange Traded Fund) which tracks the Barclay's Total Bond index versus an S&P 500 index tracking fund over a three year period and a least squares regression line approximating the relationship between the two sets of monthly total returns with a low calculated R² value. As shown in FIG. 6, the beta has an R² value of just 0.21. In short, a straight line is not a good approximation for representing the monthly returns of these two index tracking assets and therefore the beta value is not a meaningful statistic.

There are many other situations where the beta computation does not provide a meaningful statistic. When comparing the stock markets of different countries this is often the case. For instance, an investor might want to know how much more (or less) risky is the Japanese stock market compared to the Canadian market. Beta generally does not provide a meaningful statistic in this situation. There are many mutual funds that have their own proprietary mixture of assets from different asset classes for which there is no index to compare with. Some funds change their composition over time such as retirement funds which are designed to alter their asset class mix as prospective retirees come closer to the time when they will need the assets from the funds for their daily expenses. It is often desirable to compare assets from totally different asset classes, and here again it is the case that the regression line almost never achieves a reasonably good fit to the data. In these and many other situations, the requirement that there is a linear relationship between an asset and another asset or an index does not hold up and therefore beta is not useful as a measure of riskiness in these situations.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF SUMMARY OF EMBODIMENTS

Embodiments are directed to a method and apparatus for comparing the riskiness of a financial asset or index to another asset or index. The method includes computing the risk-return profile of each of the assets or indexes. The risk-return profile of an asset provides a multidimensional risk metric having a range of total return component and an asset hold time component. The risk-return profile graphically depicts the riskiness of holding an asset for a plurality of asset hold times. The range of total return component quantifies the mean total return, the average negative return, the worst case total return and optionally, a percentile total return for a given asset hold time. The asset hold time component provides hold times of various durations. Together, they answer the twin questions, “how much can one expect from an asset, and when can one expect that return”.

The range of total return component of risk is clearly an element of the degree of riskiness of an asset. If an asset price can go to zero (a loss of 100%) that asset will be seen to be more risky than another asset that can only lose half its value. Any measure of asset risk must contain a component that describes, in a quantitative way, the range of negative and positive returns that are possible while holding a financial asset.

The asset hold time component of risk is an essential component of risk as well. The price of an asset fluctuates and can decline for many years before returning to its previous price. Investment in assets having a price that takes longer to rebound to the previous price is considered to be riskier than an investment in assets having a price that bounces back more quickly. Furthermore, an asset that takes five years to return to its long term growth rate is more risky than an asset that takes only a year to return to its long term growth rate.

Embodiments provide a method that compares a weighted sum of the average negative total returns, the worst case and percentile total returns from a risk-return profile for one asset to those of another asset or index in order to quantify the degree of riskiness of one asset to another asset or market index. This method has virtually none of the limitations inherent in the traditional standard deviation and beta methods of relative risk assessment.

### BRIEF DESCRIPTION OF THE DRAWINGS

In the following drawings like reference numbers are used to refer to like elements. Although the following figures depict various examples, the implementations described herein are not limited to the examples depicted in the figures.

FIG. 1 is a graph of an asset with increasing prices and an asset with decreasing prices but each set of prices has the same standard deviation illustrating that standard deviation does not record if an asset is going up or down in price and therefore is not a very good risk measure.

FIG. 2 is a graph of an asset with a 200% gain in asset prices and a second asset whose value goes to zero, yet the standard deviation method of assessing risk calculates that the former asset is twice as risky as the latter asset.

FIG. 3 is a graph of the fluctuating prices about the mean of an asset's prices over time illustrating that the deviation from the mean of the asset's prices does not record the greatest fluctuation in prices which is from a local maximum to a local minimum price level.

FIG. 4 is the graph of the prices of two assets over time, with one asset's price clearly showing greater fluctuations than the asset prices represented by the dashed line, but each set of asset prices have exactly the same standard deviation.

FIG. 5 is the graph of the monthly total returns for the Fidelity Magellan mutual fund versus an S&P 500 index tracking fund over a three year period and a least squares regression line approximating the relationship between the two sets of monthly total returns with a high calculated R² value showing the straight line to be a good approximation to the monthly total return data points of the two assets.

FIG. 6 is the graph of the monthly total returns for an ETF (Exchange Traded Fund) which tracks the Barclay's Total Bond index versus an S&P 500 index tracking fund over a three year period and a least squares regression line approximating the relationship between the two sets of monthly total returns with a low calculated R² value showing the straight line to be a very poor approximation to the data points and therefore the traditional Beta statistic is an unreliable assessment of the relative riskiness for these two assets.

FIG. 7 is the graphical representation of the Risk Return profile of the New Markets Income Fund showing average annualized total returns, the average negative total return, the worst case total return and the 95-th percentile total return for all 12 holding times covering the three year period 2009 through 2012.

FIG. 8A is the graphical representation of the Risk Return profile of the New Markets Income Fund showing average annualized total returns, the average negative total return, the worst case total return and the 95-th percentile total return for all 12 holding times covering the three year period 2009 through 2012.

FIG. 8B is the graphical representation of the Risk Return profile of the Lehman Aggregate Bond Fund which tracks the Barclay's Aggregate U.S. Bond Index showing average annualized total returns, the average negative total return, the worst case total return and the 95-th percentile total return for all 12 holding times covering the three year period 2009 through 2012.

FIG. 9 is a schematic representation of an apparatus capable of implementing a method of displaying a financial asset risk-return profile in accordance with some embodiments.

FIG. 10 is a flow chart illustrating a method for displaying a financial asset risk-return profile, under some embodiments.

FIG. 11 is a schematic representation of a risk-return profile, under some embodiments.

FIG. 12 is a flow chart illustrating a method for displaying a risk tolerance level in the risk-return profile, under some embodiments.

FIG. 13 is a schematic representation of the risk-return profile showing the risk tolerance level, under some embodiments.

FIG. 14 is a diagram that illustrates an overall method of computing weighted BetaX values based on risk-return profiles for two assets, under an embodiment.

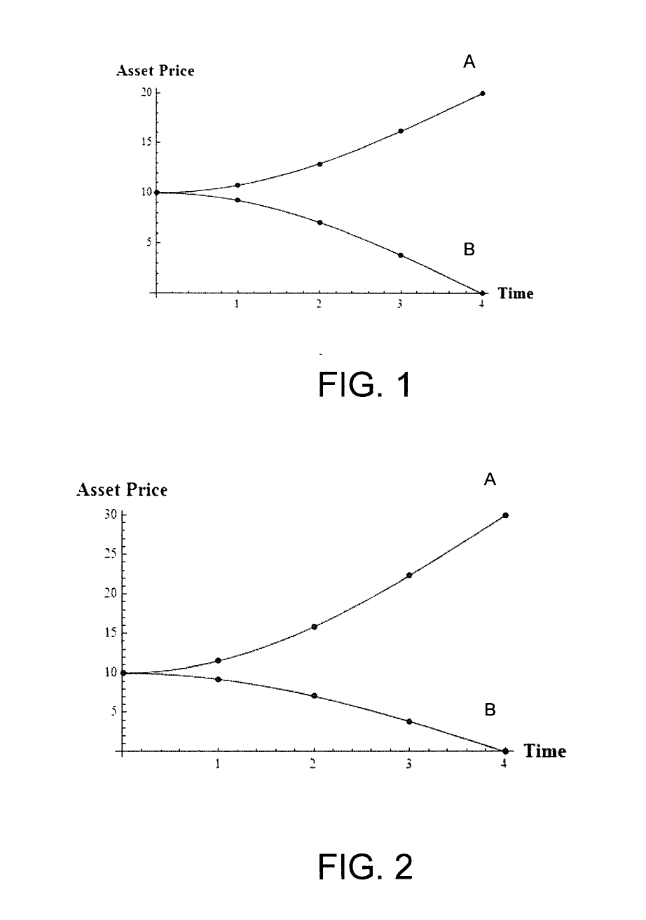

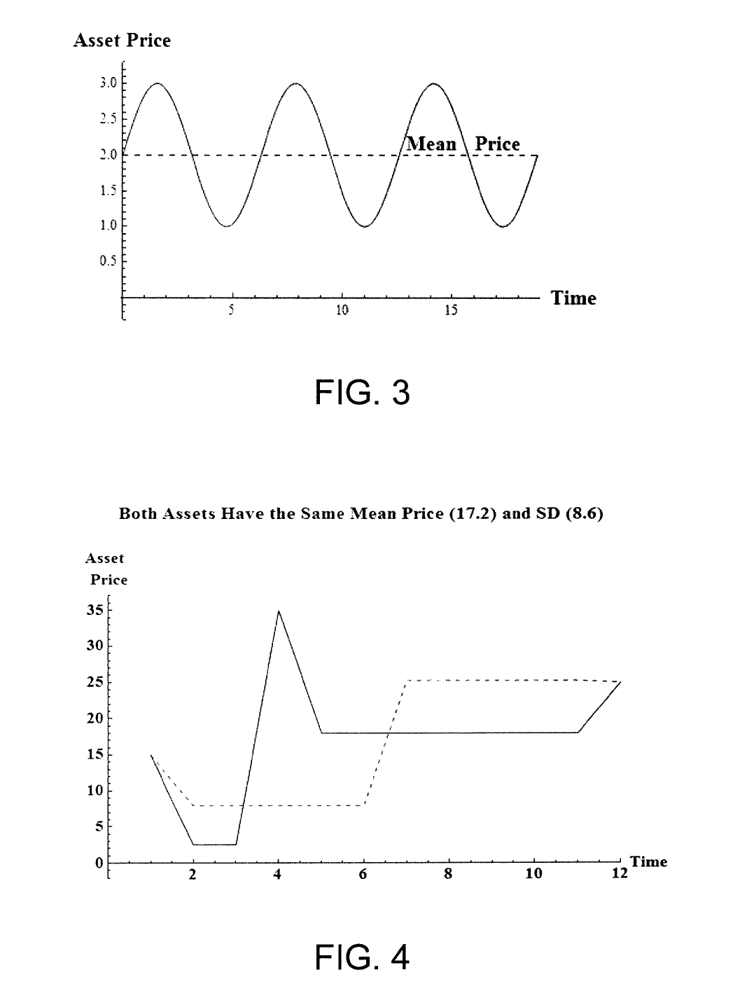

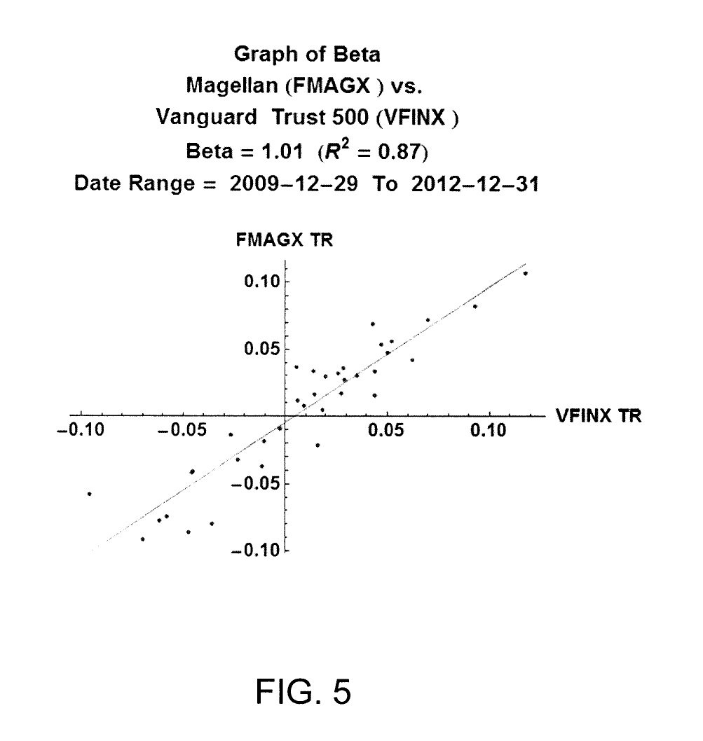

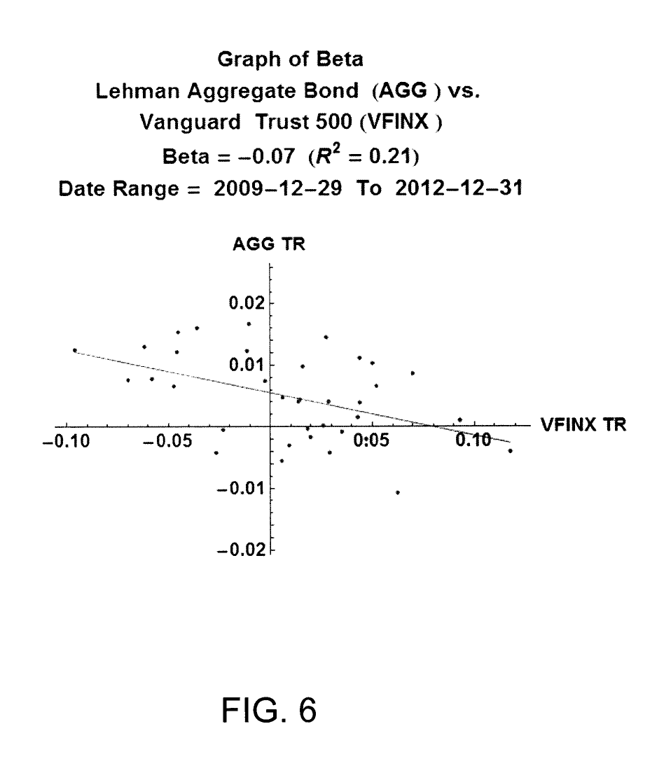

### DETAILED DESCRIPTION OF THE INVENTION

Embodiments of systems and methods are described for comparing the relative riskiness of a financial asset or index to another asset or index. Such embodiments may be used in conjunction with systems and methods for calculating and displaying a financial asset risk-return profile.

### DEFINITIONS AND NOMENCLATURE

For purposes of this description, the following definitions apply. A financial asset or asset includes any financial instrument including, but not limited to, stocks, mutual funds, exchange traded funds, bonds, options and futures contracts as well as portfolios of these assets. An asset also includes a portfolio of such financial instruments. Risk is defined as losing value in an asset, which is quantified as negative total return. A period is a fixed time duration such as two weeks, six months or one year. An interval is a length of time that comprises an integer number of periods. For example, given a period of six months, an interval includes six months, twelve months, eighteen months and so on. An asset hold time is measured in intervals. Asset price is the same as the net asset price. The total return of an asset is a function of the change in the asset price plus any income including interest, dividends and distributions. The total return is expressed as a percentage gain or loss of the original amount invested in the asset. An asset holding time is an integral number of period, such as days, weeks, months, etc. A reporting period is a subset of the overall asset date range and represents the granularity of net asset value data based on the asset price. A user selected period is a period that is defined by a user for measuring a return for the financial asset based on the net asset values; the user selected period is not required to be equal to or dependent on the reporting period, although it may be equal in certain cases. A drawdown is defined as a negative total return of an asset.

### BetaX Measure

To overcome the disadvantages associated with standard deviation and beta-based risk metrics, a new measure referred to as “BetaX” has been developed. The purpose of BetaX is to quantify how much more or less risky an asset is relative to another asset or market index. It is designed to give an accurate characterization of the relative riskiness of an asset as compared to another asset or market index without the limitations of the traditional metrics of standard deviation, beta and their derivatives. BetaX is essentially a financial asset relative risk measure that defines how much more or less risky one financial asset is relative to asset or market index.

To derive a calculation of the BetaX measure, certain assumptions are made and are as follows:

(1) There are two generic financial assets designated A and B for which it is desirable to calculate the BetaX value comparing the degree of riskiness of asset A relative to asset B.

(2) Assets A and B have daily closing prices over the same period of time. The choice of daily closing prices is for the sake of providing a concrete example, but BetaX is applicable to time series prices at any level of granularity including intraday pricing to monthly pricing or any other user defined time unit.

(3) For each asset, there is a Risk-Return (RR) profile that consists of M holding times. Consistent with the definition of a RR profile, a holding time is an integral number of periods where a period, user selected, has a duration of P days. In the examples below, the RR profile period is one quarter (3 months) and the number of holding times, M, is 12, which implies the holding times are from three months to thirty-six months (three years) in three-month increments.

(4) Both RR profiles have, for every holding time, an average annualized TR (total return), an average negative TR, a worst case negative TR and a 95^{th} percentile negative TR, the latter three designated S_{Xi}, T_{Xi}, U_{Xi} respectively where X is equal to A or B, designating assets A and B respectively, and i is the number of the holding period which is an integer between 1 and M inclusive. Thus:

S=average negative TR

T=worst-case negative TR

U=95^{th} percentile negative TR

With regard to the percentile measure, it should be noted that any other percentile besides the 95^{th} percentile could be chosen for the value of the U_{Xi} such as the 99^{th} percentile or the 90^{th} percentile.

In an embodiment, the BetaX is expressed as follows:

$$BetaX = \frac{{\sum }_{i = 1}^{M} {K}_{Ai} {w}_{Ai}}{{\sum }_{i = 1}^{M} {K}_{Bi} {w}_{Bi}}$$

In the above equation, K_{Ai} equals S_{Ai}, T_{Ai} or U_{Ai} and K_{Bi} equals S_{Bi}, T_{Bi} or U_{Bi} from the RR profiles of assets A and B; and w_{Ai} and w_{Bi} are weighting factors that are equal to 0 when the value of the corresponding K_{Ai} or K_{Bi} is positive and equal to 1 otherwise.

For the average negative total return calculation of BetaX, the BetaX definition becomes:

$$BetaX = \frac{{\sum }_{i = 1}^{M} {S}_{Ai} {w}_{Ai}}{{\sum }_{i = 1}^{M} {S}_{Bi} {w}_{Bi}} = \frac{{\sum }_{i = 1}^{M} {S}_{Ai}}{{\sum }_{i = 1}^{M} {S}_{Bi}}$$

The last equality in the above equation holds because SAi and SBi, the average negative total returns, are never positive by definition. In this case, the BetaX statistic is the ratio of the sum of the average drawdowns (a drawdown is a negative total return) of asset A to the corresponding sum for asset B over the duration of the holding times. It becomes, in effect, an approximation to the Riemann integral of the average drawdowns of asset A to the drawdowns of asset B over the duration of the RR profile.

Over time, asset B experiences an average drawdown and the negative total returns of asset A can be expected, on average, to be BetaX times the average declines of asset B. In general, the BetaX statistic for average negative total return describes the average riskiness of asset A compared to that of asset B.

For the worst case total return calculation of BetaX, the BetaX definition becomes:

$$BetaX = \frac{{\sum }_{i = 1}^{M} {T}_{Ai} {w}_{Ai}}{{\sum }_{i = 1}^{M} {T}_{Bi} {w}_{Bi}}$$

This equation may be interpreted as the ratio of the decline in total return for asset A over the relevant holding times relative to that of asset B when both are experiencing their worst declines. The worst case total return Beta describes the ratio of the drawdowns of asset A relative to those of asset B under the serverest market conditions for both assets.

For the 95^{th} percentile total return calculation of BetaX, the BetaX definition becomes:

$$BetaX = \frac{{\sum }_{i = 1}^{M} {U}_{Ai} {w}_{Ai}}{{\sum }_{i = 1}^{M} {U}_{Bi} {w}_{Bi}}$$

This is the ratio of decline in the 95^{th} percentile negative total return for asset A to that of asset B. When both assets are experiencing their 95^{th} percentile worst total returns, this BetaX gives the expected ratio of these declines. It is the 95^{th} percentile estimate of the riskiness of asset A relative to asset B.

In an embodiment, each of the S, T, and U based BetaX values stand alone and answer different questions regarding the relative riskiness of assets. The average negative total return BetaX value answers the question of: on average, how does the average drawdown for asset A compare to the average drawdown for asset B? The worst case total return BetaX value answers the question of how do the worst drawdowns of asset A compare to the worst drawdowns of asset B? The 95th percentile total return value answers the question of: how do the 95th percentile drawdowns of asset A compare to those of asset B?

The user may select any or all of the BetaX values to be calculated during the course of analysis. The user may also calculate more than one of these values and choose to compare the BetaX values between two assets to get a more detained picture of the relationship between the drawdowns of asset A relative to asset B.

In general, the BetaX value is unitless since it is a ratio. In an embodiment, BetaX may vary along a range of values similar to the traditional beta statistic. For example, when comparing asset A to asset B, a BetaX value less than 1 means that asset A is less risky than asset B; a BetaX value equal to 1 means that the assets are equally risky; and a BetaX value greater than 1 means asset A is more risky than asset B. This value range is an example, and other ranges are also possible.

With regard to specific BetaX values, and using the example range given above, the average negative total version of BetaX is less than 1, then one can say that “on average” the drawdowns of asset A are not as severe as those of asset B. In other words, asset A, on average, is not as risky as asset B. On the other hand, if the worst case total return BetaX value is greater than 1, then one can say that the worst case negative total returns of asset A are greater than those of asset B and that, therefore, in a worst case situation, asset A is riskier than asset B.

The BetaX values define a better risk measure for assets and can be used with certain Risk-Return profile computations that may be used as the basis for comparing the relative riskiness of one financial asset to another financial asset or market index.

### Example Use Case

An example is provided to illustrate the calculation of the BetaX measure as provided in the embodiments described above. This example utilizes the Fidelity New Markets Income fund (trading symbol FNMIX), which is an emerging markets bond fund which invests in US dollar denominated bond offerings in emerging market countries. Before investing in this fund, an investor would be prudent to assess how much more or less risky this bond fund is, or any other emerging markets bond fund, relative to the U.S. domestic bond market.

A broad index which represents the U.S. domestic bond market is Barclay's U.S. Aggregate Bond Index and an ETF (Exchange Traded Fund) which tracks this index is the Lehman Aggregate Bond fund (trading symbol AGG).

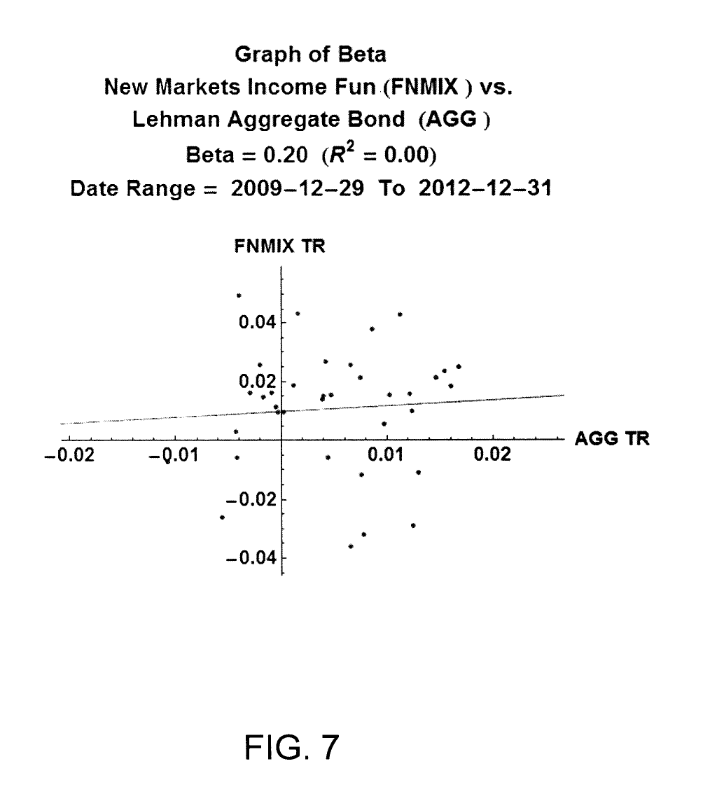

FIG. 7 depicts the graphical represention of the traditional Beta statistic comparing the relative riskiness of FNMIX to AGG. As can be seen in FIG. 7, the R² statistic is zero, showing that there is virtually no linear relationship between the monthly total returns of these assets. Therefore, Beta cannot be relied upon to adequately or reliably measure how risky FNMIX is relative to the broad U.S. domestic bond market.

Using the standard deviation traditional method gives, for the ratio of their standard deviations a value of 2.93; that is, by this method, FNMIX is assessed to be almost three times as risky at the U.S. domestic bond market. However, given the inherent limitations of the standard deviation statistic outlined in the Background section, this statistic generally cannot be relied upon. In this particular example, it greatly overestimates the relative riskiness of FNMIX as compared to the U.S. bond market.

The BetaX statistic requires that a RR profile of FNMIX and AGG be calculated. There are a total of twelve holding times with a period being three months (one quarter).

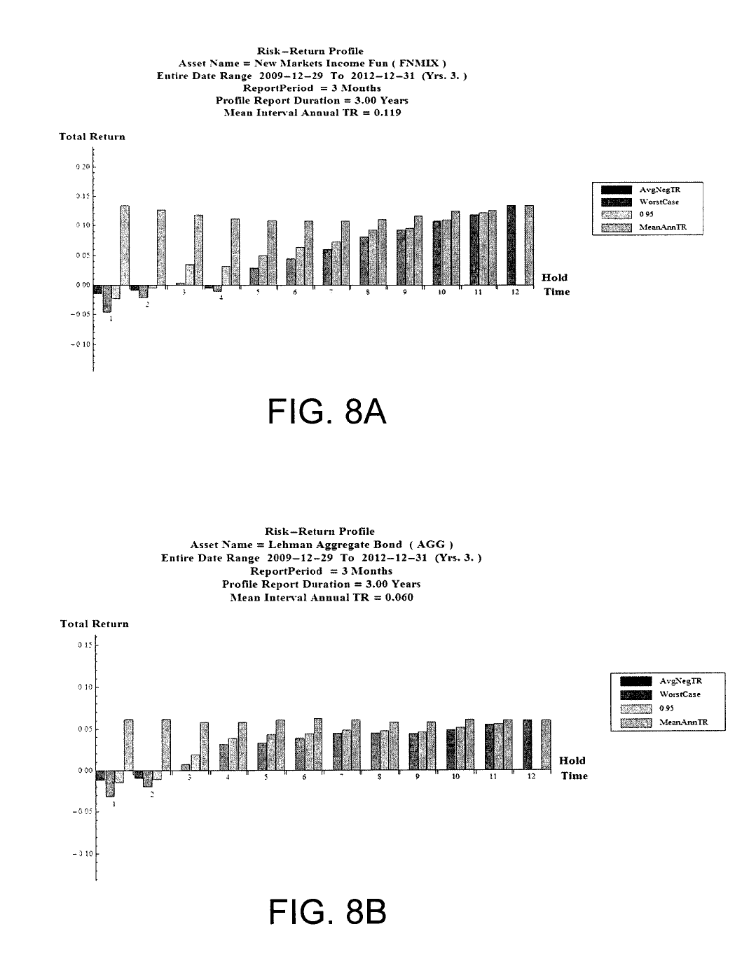

FIG. 8A is the graphical representation of the profile for FNMIX and Table 1 below is its associated numerical values for the average negative total return, S_{Ai}, worst case total return, T_{Ai}, and 95^{th} percentile total return, U_{Ai}, for each of the relevant holding periods over a three year duration covering the years 2009 through 2012.

TABLE 1

| | Inter- | | | # | Avg. | % | | |
|---|---|---|---|---|---|---|---|---|
| | val | Ann | Gr- | Inter- | Neg. | Neg | Worst | Pct. |
| | Yrs. | TR | 100. | vals | TR | TR | Case | 0.95 |
| 1 | 0.25 | 0.13 | 103.19 | 694 | −0.0142 | 0.19 | −0.0455 | −0.0220 |
| 2 | 0.50 | 0.13 | 106.16 | 631 | −0.0081 | 0.07 | −0.0207 | −0.0044 |
| 3 | 0.75 | 0.12 | 108.71 | 568 | 0.0000 | 0.00 | 0.0039 | 0.0349 |
| 4 | 1.00 | 0.11 | 111.16 | 505 | −0.0048 | 0.01 | −0.0102 | 0.0322 |
| 5 | 1.25 | 0.11 | 113.74 | 442 | 0.0000 | 0.00 | 0.0290 | 0.0501 |
| 6 | 1.50 | 0.11 | 116.63 | 379 | 0.0000 | 0.00 | 0.0449 | 0.0638 |
| 7 | 1.75 | 0.11 | 119.69 | 316 | 0.0000 | 0.00 | 0.0603 | 0.0727 |
| 8 | 2.00 | 0.11 | 123.30 | 253 | 0.0000 | 0.00 | 0.0819 | 0.0926 |
| 9 | 2.25 | 0.12 | 128.08 | 190 | 0.0000 | 0.00 | 0.0932 | 0.0960 |
| 10 | 2.50 | 0.12 | 134.04 | 127 | 0.0000 | 0.00 | 0.1076 | 0.1097 |
| 11 | 2.75 | 0.13 | 138.45 | 64 | 0.0000 | 0.00 | 0.1186 | 0.1216 |
| 12 | 3.00 | 0.13 | 145.99 | 1 | 0.0000 | 0.00 | 0.1344 | 0.0000 |

The corresponding RR profile for AGG is depicted in FIG. 8B with its associated table of numerical values in Table 2 below.

TABLE 2

| | Inter- | | | # | Avg. | % | | |
|---|---|---|---|---|---|---|---|---|
| | val | Ann | Gr- | Inter- | Neg. | Neg | Worst | Pct. |
| | Yrs. | TR | 100. | vals | TR | TR | Case | 0.95 |
| 1 | 0.25 | 0.06 | 101.50 | 694 | −0.0119 | 0.13 | −0.0318 | −0.0145 |
| 2 | 0.50 | 0.06 | 103.03 | 631 | −0.0097 | 0.10 | −0.0201 | −0.0112 |
| 3 | 0.75 | 0.06 | 104.33 | 568 | 0.0000 | 0.00 | 0.0072 | 0.0185 |
| 4 | 1.00 | 0.06 | 105.77 | 505 | 0.0000 | 0.00 | 0.0316 | 0.0385 |
| 5 | 1.25 | 0.06 | 107.62 | 442 | 0.0000 | 0.00 | 0.0329 | 0.0430 |
| 6 | 1.50 | 0.06 | 109.48 | 379 | 0.0000 | 0.00 | 0.0388 | 0.0440 |
| 7 | 1.75 | 0.06 | 110.83 | 316 | 0.0000 | 0.00 | 0.0444 | 0.0480 |
| 8 | 2.00 | 0.06 | 111.87 | 253 | 0.0000 | 0.00 | 0.0449 | 0.0474 |
| 9 | 2.25 | 0.06 | 113.46 | 190 | 0.0000 | 0.00 | 0.0440 | 0.0458 |
| 10 | 2.50 | 0.06 | 115.35 | 127 | 0.0000 | 0.00 | 0.0486 | 0.0513 |
| 11 | 2.75 | 0.06 | 117.29 | 64 | 0.0000 | 0.00 | 0.0549 | 0.0558 |
| 12 | 3.00 | 0.06 | 119.00 | 1 | 0.0000 | 0.00 | 0.0597 | 0.0000 |

Taking the values from the Tables 1 and 2 for the average (S_{Xi}), worst case (T_{Xi}) and 95^{th} percentile (U_{Xi}) total returns, the BetaX values may be calculated as shown below.

The average negative total return calculation of BetaX can be expressed as follows:

$$BetaX = \frac{{\sum }_{i = 1}^{M} {S}_{Ai}}{{\sum }_{i = 1}^{M} {S}_{Bi}} = 1.25$$

The worst case total return calculation of BetaX can be expressed as follows:

$$BetaX = \frac{{\sum }_{i = 1}^{M} {T}_{Ai} {w}_{Ai}}{{\sum }_{i = 1}^{M} {T}_{Bi} {w}_{Bi}} = 1.47$$

The 95^{th} percentile total return calculation of BetaX can be expressed as follows:

$$BetaX = \frac{{\sum }_{i = 1}^{M} {U}_{Ai} {w}_{Ai}}{{\sum }_{i = 1}^{M} {U}_{Bi} {w}_{Bi}} = 1.027$$

It will be appreciated by those skilled in the art that other weighting factors are possible including, but not limited to, the following: (1) w_{Xi}=the number of negative total returns for holding time i from the RR profile for asset X divided by the total number of total returns for holding period i from the RR profile for X; and (2) w_{Xi}=the number of negative total returns for holding time i from the RR profile for asset X divided by the total number of negative total returns across all holding times from the RR profile for asset X.

It should be noted that a weight factor for a given asset at a particular holding time can be a function of data from the profiles for both assets A and B.

The denominator value in the definition of BetaX can, very occasionally, be equal to zero in which case BetaX is not defined because division by zero in mathematics is not defined. This would only happen (the denominator equal to zero) if there are no negative total return values in the Risk-Return profile of asset B when calculating the average negative total return BetaX or if the percentile total return values are all positive from the RR profile when calculating the percentile BetaX values.

### Calculating a Financial Asset Risk-Return Profile

As stated above, the BetaX values can be used in conjunction with certain Risk-Return profile computations to provide a better risk measure for assets when comparing the relative riskiness of assets or market indices. In addition, as noted above, the BetaX calculations depend on the prior calculation of the numerical values in the RR Profiles for the relevant assets or indexes. In an embodiment, systems and methods for comparing the riskiness of a financial asset or index to another asset or index as described above may be used in conjunction with systems for computing and displaying a financial asset risk-return profile that provides a multidimensional risk metric having a range of total return component and an asset hold time component.

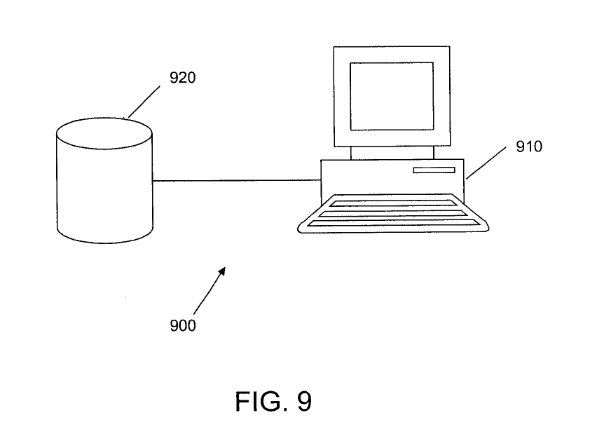

In an embodiment, a computer-implemented method for calculating and displaying a financial asset risk-return profile may be executed by a computing machine generally designated 900 in FIG. 9. Computing machine 900 may be of conventional design and capable of performing computations on large sets of data accessible from a local memory or from a communicatively coupled database 920. Computing machine 900 may be a personal computer or a server machine coupled to a communications network such as the Internet.

The computations performed by the computing machine 900 provide the metrics of the risk-return profile. The computing machine 900 is further capable of displaying the risk-return profile to a user viewing a display device 930. As is well known in the art, the computing machine 900 may have other capabilities that include a printing facility to print the risk-return profile, a formatting facility for formatting and saving the risk-return profile to the local memory, and a communication facility for sending the risk-return profile to another computing machine 900 over the communications network.

In accordance with an aspect of the method of the invention, the metrics of the risk-return profile are computed from a date range set stored in the local memory or database 920. The elements of the date range set may be the ordered net asset values of an asset at the close of each trading day. For purposes of illustration, the date range set of the Vanguard Index Trust 500 Index fund (hereinafter the VFINX date range set) from Mar. 3, 1990 through Jun. 30, 2008 is used herein. The date range set spans a time period of 18.34 years.

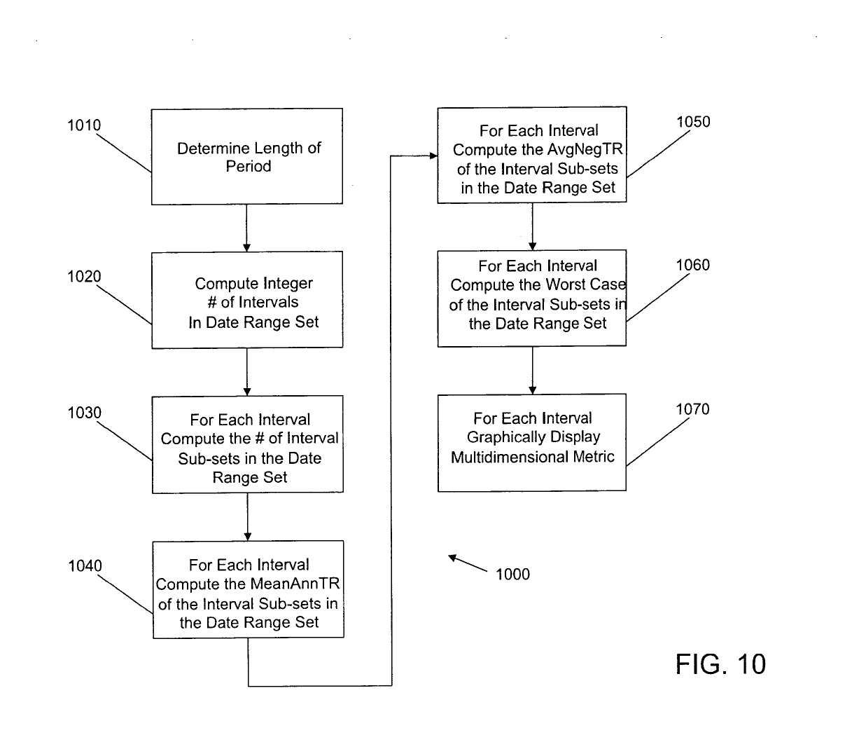

A method generally designated 1000 for displaying a financial asset risk-return profile is shown in FIG. 10. Method 1000 is preferably implemented by the computing machine 900 and in this sense is a computer-implemented method. The method elements shown in FIG. 10 may be implemented by the computing machine 900 as by the execution of instructions and/or code segments by a processor the outcome of which is the performance of a method step.

In a step 1010, the time duration or length of a period is determined. The time duration of the period may be user-selected or a default value. For purposes of illustration, a period of one year is used herein. An integer number of intervals in the date range set are computed in a step 1020. The integer number of intervals is 18 for the period of one year and the VFNIX date range set spanning 18.34 years. A first interval spans one year, a second interval spans two years and so on. As the asset hold time is measured intervals, there are 18 asset hold times including a one year asset hold time, a two year asset hold time and so on up to, and including, an eighteen year asset hold time.

For each interval, the number of interval sub-sets in the date range set is computed in a step 1030. An interval sub-set spans the length of the interval and represents one of a plurality of possible asset hold times. The set of interval sub-sets represents the plurality of possible asset hold times. For the VFNIX date range set, there are 4370 interval sub-sets having a length of one year, 4118 interval sub-sets having a length of two years and so on. For each interval, the interval sub-sets provide a plurality of sets of data representing equal hold times throughout the date range set.

In a step 1040, for each interval the mean annualized total return of the interval sub-sets in the date range set is computed. The annualized total return of each interval sub-set is given by:

annTR=ê[Ln(TR+1.)/nYrs]−1.0

In the above equation, annTR=the annualized total return of an interval sub-set, TR=the total return for the interval sub-set, and nYrs=the length of the interval sub-set in years. The mean annualized total return is determined from the annualized total returns of the interval sub-sets. Execution of step 1040 thus provides a mean annualized total return for each interval or asset hold time.

For each interval, the average negative total return of the interval sub-sets is computed in a step 1050. The average negative total return is the average of the total returns of interval sub-sets having a negative value and answers the question: “If there are one or more negative total returns for a given interval, what is the average value of the negative total returns.” If there are n negative total returns for a given interval (corresponding to n interval sub-sets having a negative total return), then:

avgNegTR=(TR₁+TR₂+ . . . TRₙ)/n

In the above equation, avgNegTR=the average negative total return and TR₁, TR₂ . . . TRₙ=the negative total returns of the interval sub-sets having a negative total return. The average negative total return is annualized only for the one-year interval and is otherwise cumulative. The average negative total return is not annualized for intervals and asset hold times other than one year so that the magnitude of a potential loss is not masked by an annualized value.

In a step 1060, for each interval, the worst-case total return of the interval sub-sets is computed. The worst case total return is as follows:

worst case TR=min(TR₁,TR₂, . . . ,TRₘ)

In the above equation, worst case TR=the worst-case TR and min(TR₁, TR₂, . . . , TRₘ) equals the minimum value of the total returns of the interval sub-sets. The worst-case total return may be negative or positive. In the case where the worst-case total return is positive, its value is annualized. Otherwise, the value is not annualized. The worst-case total return is cumulative if its value is negative so that the magnitude of a potential loss is not masked by an annualized value.

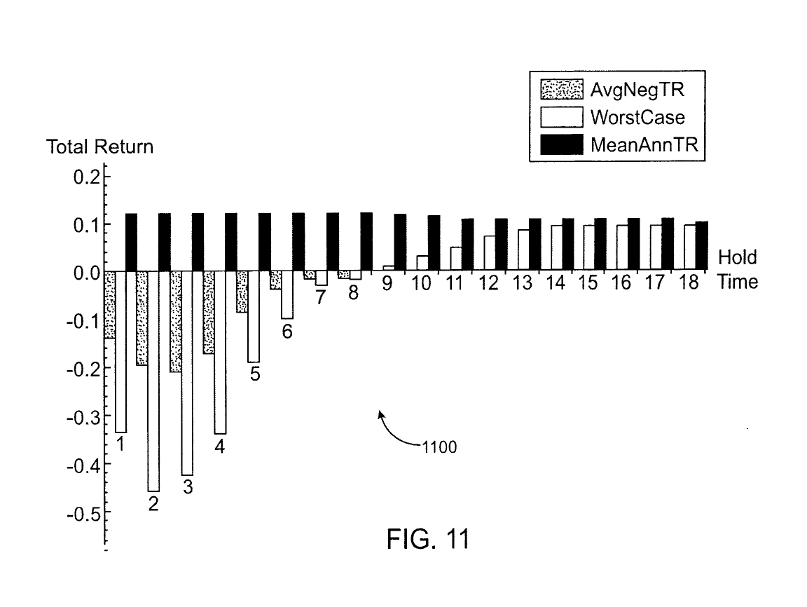

The metrics computed in steps 1040, 1050 and 1060 (the mean annualized total return, the average negative total return and the worst case total return of an asset) are graphically displayed for each interval or asset hold time in a step 1060. The metrics are graphically displayed in a risk-return profile 1100 of an asset as shown in FIG. 11. The risk-return profile 1100 includes a bar graph having a total return axis and an asset hold time axis. For each asset hold time, the computed mean annualized total return, average negative total return and worst case total return are graphed. A table corresponding to the metrics graphically displayed in the risk-return profile 1100 (Table 1) may also be graphically displayed. Table 3 below displays additional information including what an investment of $100 would grow to, on average, at the end of each asset hold period (GR-100) and the percentage of time that, for a given asset hold time, there was a negative total return.

TABLE 3

| | Inter- | | | # | Avg. | % | |
|---|---|---|---|---|---|---|---|
| | val | Ann | Gr- | Inter- | Neg. | Neg | Worst |
| | Yrs. | TR | 100. | vals | TR | TR | Case |
| 1 | 1.00 | 0.12 | 112.00 | 4370 | −0.14 | 0.18 | −0.33 |
| 2 | 2.00 | 0.12 | 126.22 | 4118 | −0.19 | 0.17 | −0.46 |
| 3 | 3.00 | 0.13 | 142.73 | 3866 | −0.21 | 0.17 | −0.42 |
| 4 | 4.00 | 0.13 | 161.27 | 3614 | −0.17 | 0.20 | −0.34 |
| 5 | 5.00 | 0.13 | 182.63 | 3362 | −0.08 | 0.21 | −0.19 |
| 6 | 6.00 | 0.12 | 202.35 | 3110 | −0.04 | 0.09 | −0.10 |
| 7 | 7.00 | 0.12 | 225.67 | 2858 | −0.02 | 0.00 | −0.03 |
| 8 | 8.00 | 0.12 | 250.27 | 2606 | −0.02 | 0.00 | −0.02 |
| 9 | 9.00 | 0.12 | 274.95 | 2354 | 0.00 | 0.00 | 0.01 |
| 10 | 10.00 | 0.11 | 293.32 | 2102 | 0.00 | 0.00 | 0.03 |
| 11 | 11.00 | 0.11 | 308.36 | 1850 | 0.00 | 0.00 | 0.05 |
| 12 | 12.00 | 0.11 | 333.80 | 1598 | 0.00 | 0.00 | 0.07 |
| 13 | 13.00 | 0.11 | 376.53 | 1346 | 0.00 | 0.00 | 0.08 |
| 14 | 14.00 | 0.11 | 417.03 | 1094 | 0.00 | 0.00 | 0.09 |
| 15 | 15.00 | 0.11 | 461.50 | 842 | 0.00 | 0.00 | 0.09 |
| 16 | 16.00 | 0.11 | 516.76 | 590 | 0.00 | 0.00 | 0.09 |
| 17 | 17.00 | 0.11 | 582.06 | 338 | 0.00 | 0.00 | 0.09 |
| 18 | 18.00 | 0.10 | 559.10 | 86 | 0.00 | 0.00 | 0.09 |

The risk-return profile 1100 provides a graphical depiction of the riskiness of holding an asset over the plurality of hold times and includes the total return component and the asset hold time component of risk. By utilizing the maximum amount of information related to an asset's historical price movement, the risk-return profile 1100 provides both the amount of return and when the return can be expected. For example, the risk-return profile 1100 shows that the unluckiest investor would be required to hold the Vanguard Index Trust 500 Index fund for nine years to return to parity as the worst case total return becomes a positive value after the asset hold time of nine years.

The number of intervals in the “# intervals” column is a function of the date range duration and reporting period of the data as well as the user selected period. For example, in Table 3, the date range is 18.34 years and the reporting period of the data is daily. An interval is defined to be an integral number of periods. The user selected period in Table 3 is assumed to be one year. Therefore, the possible interval durations that can fit into a 18.34 year date range of the data are one year, two years, up to a maximum interval of 18 years. When the interval is of duration one year, there is a total of 4370 possible intervals within the given date range. When the interval is at its maximum of 18 years, there is a total of 86 possible intervals of this size within the date range of 18.34 years.

In an embodiment, the number of intervals may be calculated from the following formula, assuming that the granularity of the data in the database is daily closing prices:

number-of-intervals=m−(p×i)+1 for 1≦1≧N

In the above equation:
m=the number of days in the date range of the data
p=the number of days in a user selected period
N=integer part of (m/p)
i=the integer number of periods which defines an interval duration.

For the risk-return profile represented by the numerical values in Table 3, the values for m, p, N and i are as follows: m=4621 days (18.34 years), p=252 days (trading days in 1 year), N=18 (the integer part of 4621/252), and i=the integers 1 through 18. Using these values for m, p, N and i in the above formula equals the values in the #intervals column in Table 3. For instance, when i=18, the formula gives: 4621−(252×18)+1=86 for the number of intervals. When i=1, the formula gives 4621−(252×1)+1=4370 for the number of intervals.

Essentially, Table 3 shows that the number 86 (for year 18) is derived by observing that there only are 86 ways for an interval with duration of exactly 18 years to fit into a date range of 18.34 years. For example, the interval can start on day one of the data with a date range of 18.34 years and extend out for 18 years of daily closing prices, but the end of the interval would not be co-incident with the last day of the 18.34 date range. The interval can start on day 2 of the data and so on, until the end of the interval bumps up against the end of the 18.34 yr. date range. The number of times the 18 year interval can be moved forward in time this way is 86 until the date range is exhausted.

If the granularity of the data in the data base is other than daily (as used in the example above), similar formulas may be derived to calculate the number-of-intervals values for the #interval column in a table representing risk-return profiles, such as Table 3.

In accordance with another aspect of the method of the invention, a risk tolerance level can be graphically displayed in a risk-return profile. The worst-case total return of the risk-return profile 1100 quantifies the most negative total return for an asset hold time. It represents the most pessimistic scenario about what has happened to the asset's total return over the historical period covered by the risk-return profile 1100. For planning purposes, this may not be the most useful view of the data covered by the risk-return profile 1100 as it may represent too pessimistic a view going forward.

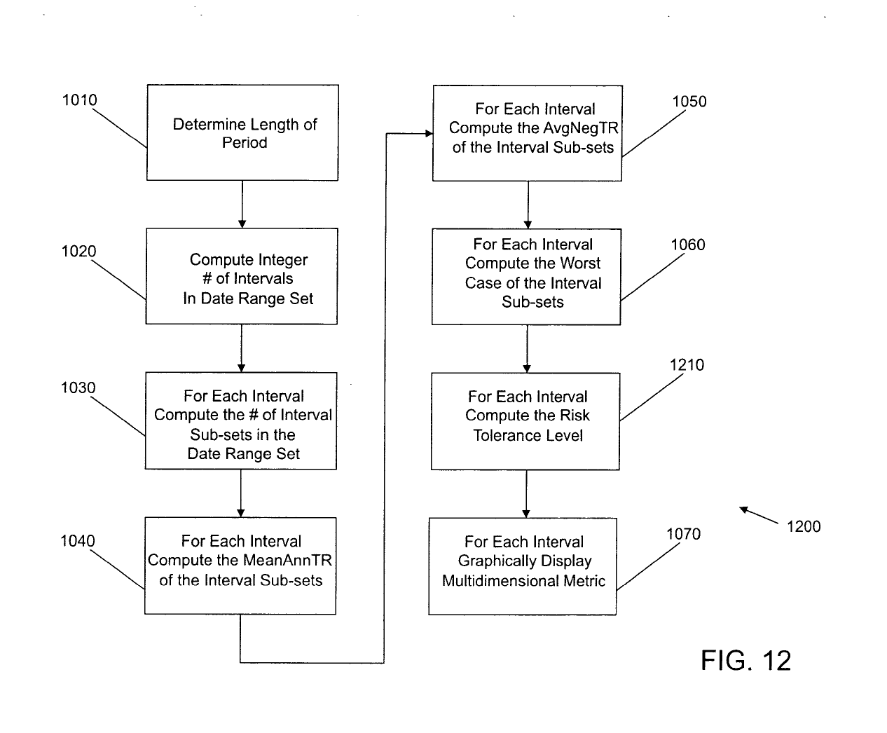

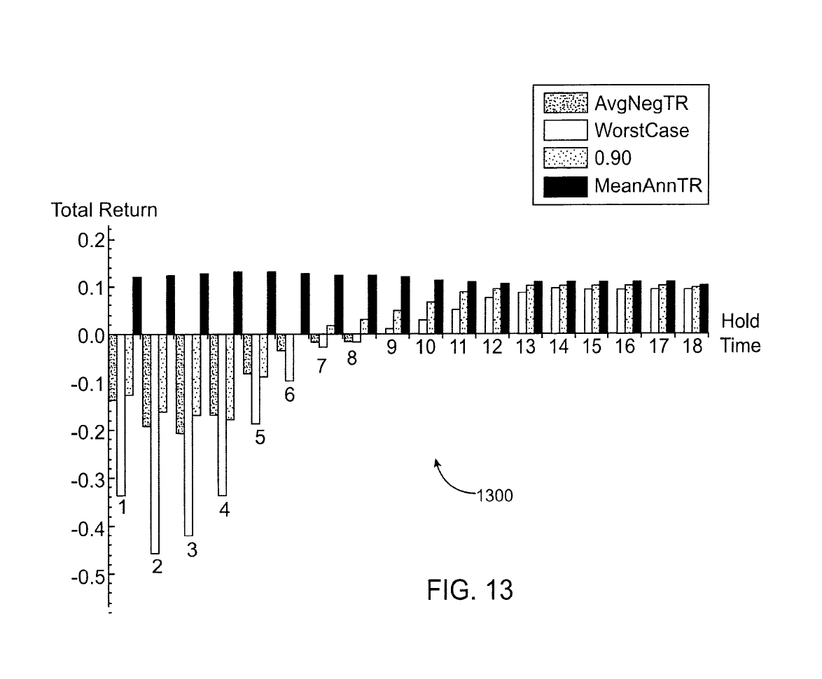

With reference to FIG. 12, a method generally designated 1200 for displaying a risk tolerance level includes the method steps of the method 1000 and an additional step 1210 in which a risk tolerance level is computed. An exemplary risk tolerance level of 90% is graphically displayed in a risk-return profile 1300 as shown in FIG. 13 and numerically shown in Table 4 below. The values represented by the bars designated “0.90” are computed by finding the total return that represents the 90^{th} percentile of all total returns of the interval sub-sets for a given asset hold time or interval. This total return is the total return for which, out of all the total returns for a given hold time, only 10% are less than the 90^{th} percentile total return. In general, if TR is the total return that represents the X-th percentile this implies that (100−X) % of all the total returns for the given hold time are less than TR. In this case, X % is referred to as the “risk tolerance level” or, in shorthand, simply the risk level. If TR is negative, the value is displayed as a cumulative total return, otherwise it is annualized.

TABLE 4

| | Inter- | | | # | Avg. | % | | |
|---|---|---|---|---|---|---|---|---|
| | val | Ann | Gr- | Inter- | Neg. | Neg | Worst | Pct. |
| | Yrs. | TR | 100. | vals | TR | TR | Case | 0.30 |
| 1 | 1.00 | 0.12 | 112.00 | 4370 | −0.14 | 0.18 | −0.33 | −0.13 |
| 2 | 2.00 | 0.12 | 126.22 | 4118 | −0.19 | 0.17 | −0.46 | −0.16 |
| 3 | 3.00 | 0.13 | 142.73 | 3866 | −0.21 | 0.17 | −0.42 | −0.17 |
| 4 | 4.00 | 0.13 | 161.27 | 3614 | −0.17 | 0.20 | −0.34 | −0.18 |
| 5 | 5.00 | 0.13 | 182.63 | 3362 | −0.08 | 0.21 | −0.19 | −0.09 |
| 6 | 6.00 | 0.12 | 202.35 | 3110 | −0.04 | 0.09 | −0.10 | 0.00 |
| 7 | 7.00 | 0.12 | 225.67 | 2858 | −0.02 | 0.00 | −0.03 | 0.02 |
| 8 | 8.00 | 0.12 | 250.27 | 2606 | −0.02 | 0.00 | −0.02 | 0.03 |
| 9 | 9.00 | 0.12 | 274.95 | 2354 | 0.00 | 0.00 | 0.01 | 0.05 |
| 10 | 10.00 | 0.11 | 293.32 | 2102 | 0.00 | 0.00 | 0.03 | 0.06 |
| 11 | 11.00 | 0.11 | 308.36 | 1850 | 0.00 | 0.00 | 0.05 | 0.09 |
| 12 | 12.00 | 0.11 | 333.80 | 1598 | 0.00 | 0.00 | 0.07 | 0.09 |
| 13 | 13.00 | 0.11 | 376.53 | 1346 | 0.00 | 0.00 | 0.08 | 0.10 |
| 14 | 14.00 | 0.11 | 417.03 | 1094 | 0.00 | 0.00 | 0.09 | 0.10 |
| 15 | 15.00 | 0.11 | 461.50 | 842 | 0.00 | 0.00 | 0.09 | 0.10 |
| 16 | 16.00 | 0.11 | 516.76 | 590 | 0.00 | 0.00 | 0.09 | 0.10 |
| 17 | 17.00 | 0.11 | 582.06 | 338 | 0.00 | 0.00 | 0.09 | 0.10 |
| 18 | 18.00 | 0.10 | 559.10 | 86 | 0.00 | 0.00 | 0.09 | 0.10 |

Risk tolerance levels can be assigned to a various investor risk tolerances. A risk tolerance level of 100% (depicted as the worst case total return in risk-return profile 1100) may be assigned to the most conservative and risk adverse investor. A risk tolerance level of 90% (depicted as the 0.90 total return in the risk-return profile 1300) may be assigned to a moderately conservative investor; a risk tolerance level of 80% to a moderately aggressive investor, a risk tolerance level of 70% to an aggressive investor, and a risk tolerance level of 60% to a very aggressive investor. Those skilled in the art will recognize that other risk tolerance levels may be assigned to quantify the levels of investor risk tolerance.

Risk tolerance levels can be used for example by a firm of financial advisors seeking to define risk tolerance levels consistently throughout the firm. In this way, if an advisor goes on vacation or leaves the firm, another advisor at the firm will have an unambiguous means of knowing the risk tolerance levels of the particular clients that the vacationing or former advisor was working with.

In accordance with another aspect of the invention, a plurality of quantities of interest can be extracted from a risk-return profile of an asset. Such quantities of interest are termed factors and include a maximum drawdown factor and a recoupment time factor. The maximum drawdown factor is the most negative total return for the asset. With reference to FIG. 11, the maximum drawdown factor for the VFINX fund is −0.46 for an asset hold time of two years. The recoupment time factor is the time it takes for the asset to recoup its losses given that there has been an initial loss of asset value from the time the asset was first acquired. The recoupment time factor for the VFINX fund is nine years and thus it will take the unluckiest of investors nine years to recoup his or her losses in the worst-case scenario.

In accordance with another aspect of the invention, ratios of factors may be used to compare the performance of two assets. For example, the recoupment time factor for the VFINX fund is nine years. Assuming another asset has a recoupment time factor of three years, a ratio of the recoupment time factors yields a value of ⅓ for the asset relative to the VFINX fund. The ratio of recoupment time factor can thus be used to compare the performance of the assets.

In accordance with another aspect of the invention, a conditional risk-return profile of an asset can be displayed. Metrics are computed and displayed only upon the occurrence of the condition. For example, it may be useful to know the recoupment time factor following a 20% decline in the value of an asset. If an asset has declined in value by 20%, then the conditional risk-return profile of the asset displays the recoupment time. If the asset has not declined in value by 20%, no data is displayed in the conditional risk-return profile of the asset.

In accordance with another aspect of the invention, metrics of at least two assets can be displayed in a comparison risk-return profile of the assets. For example, a comparison of the mean annualized total returns of the assets as a function of the asset hold times may be displayed. Those skilled in the art will appreciate that other metrics can be similarly and comparatively displayed.

In describing the risk-return profile of an asset, a period of one year has been used. Those skilled in the art will recognize that the duration of the period can be arbitrarily small but greater than zero and is only limited by the date range duration of the data.

Furthermore, a risk-return profile does not have to represent all of the data in the date range set. For example, a sub-set of the date range set can be used in making the computations of the disclosed methods. Additionally, the date range set may include any historical data that forms a time series including the total return values for an asset.

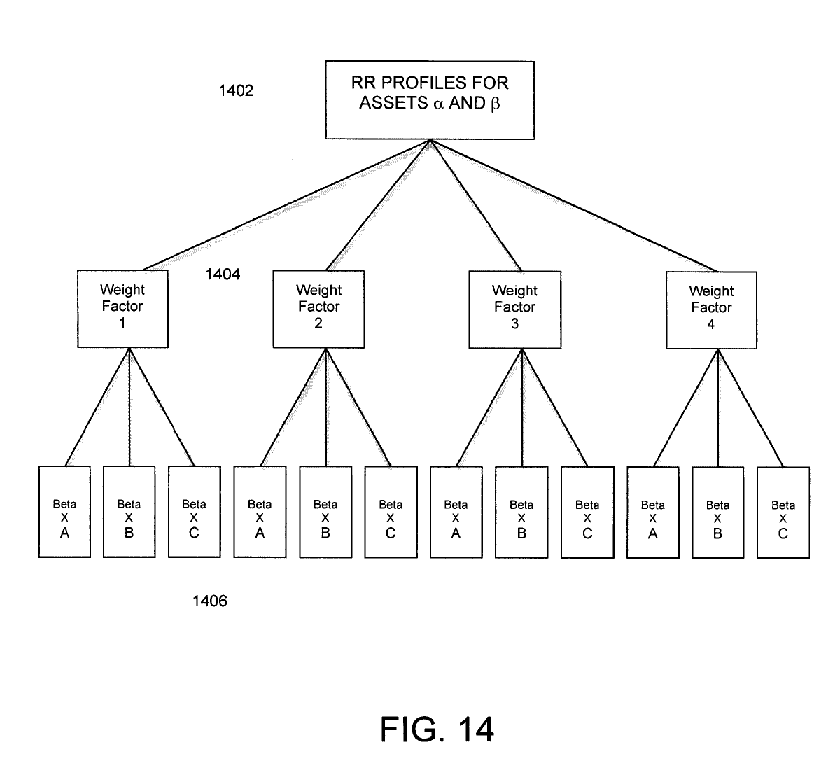

FIG. 14 is a diagram that illustrates an overall method of computing weighted BetaX values based on risk-return profiles for two assets, under an embodiment. As shown in FIG. 14, risk return profiles are derived for two assets denoted assets α and β. Four different weight factors 1404 are then generated. These weight factors are as follows: (1) a value of one if an associated value for that holding time from the risk-return profile is negative, and a value of zero if the associated value for that holding time from the risk-return profile is non-negative; (2) the number of negative total returns for a respective holding time from the risk-return profile divided by the total number of total returns for that holding period from the risk return profile; (3) the number of negative total returns for a respective holding time from the risk-return profile divided by the total number of negative total returns across all holding periods from the risk return profile; and (4) a number that is a function of the risk-return profiles for both assets.

Using the weighting factors, each of the three BetaX values 1406 denoted A, B, and C are calculated. The BetaX values comprise the average negative total return BetaX, the worst case drawdown BetaX, and the percentile drawdown BetaX. In an alternative embodiment, the BetaX values may be calculated directly from the risk-return profiles 1402 without the weights 1404, as unweighted BetaX values.

Aspects of the one or more embodiments described herein may be implemented in a networked computer system comprising computers or processing devices executing software instructions. Any of the described embodiments may be used alone or together with one another in any combination. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

Aspects of the systems described herein may be implemented in a distributed computer system that may include one or more networks that comprise any desired number of individual machines, including one or more routers (not shown) that serve to buffer and route the data transmitted among the computers. Such a network may be built on various different network protocols, and may be the Internet, a Wide Area Network (WAN), a Local Area Network (LAN), or any combination thereof.

One or more of the components, blocks, processes or other functional components may be implemented through a computer program that controls execution of a processor-based computing device of the system. It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical (non-transitory), non-volatile storage media in various forms, such as optical, magnetic or semiconductor storage media.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A computer-implemented method for comparing risk associated with a first financial asset with a second financial asset, comprising:
creating a risk-return profile for the first asset and a risk profile for the second asset over a defined time period having a plurality of asset holding times;
calculating an average negative total return for each of the first and second assets for each of the plurality of asset holding times;
calculating a worst case total return for the first and second assets for each of the plurality of asset holding times; and
calculating a percentile total return for the first and second assets for each of the plurality of asset holding times.

2. The method of claim 1 further comprising defining a BetaX measure that defines how much more or less risky the first asset is relative to the second asset, and wherein a specific BetaX measure is associated with each of the average negative total return, the worst case total return, and the percentile total return, and wherein a drawdown comprises a total negative return for an asset.

3. The method of claim 2 further comprising calculating an average negative total return BetaX as the ratio of the sum of the average drawdowns of the first asset to the corresponding sum for the second asset over the duration of the holding times.

4. The method of claim 2 further comprising calculating a worst case total return BetaX as the ratio of the sum of the worst case drawdowns of the first asset to the corresponding sum for the second asset over the duration of the holding times.

5. The method of claim 2 further comprising calculating a percentile total return BetaX as the ratio of the sum of the percentile drawdowns of the first asset to the corresponding sum for the second asset over the duration of the holding times.

6. The method of claim 2 further comprising applying a weight factor for each holding time of the plurality of holding times, and wherein the weight factor is selected to be one of the following:
(1) a value of one if an associated value for that holding time from the risk-return profile is negative, and a value of zero if the associated value for that holding time from the risk-return profile is non-negative;
(2) the number of negative total returns for a respective holding time from the risk-return profile divided by the total number of total returns for that holding period from the risk return profile;
(3) the number of negative total returns for a respective holding time from the risk-return profile divided by the total number of negative total returns across all holding periods from the risk return profile; and
(4) a number that is a function of the risk-return profiles for both assets.

7. The method of claim 6 further comprising using the weight factor to calculate a negative total return BetaX as the ratio of the sum of weighted average drawdowns of the first asset to the corresponding sum for the second asset over the duration of the holding times.

8. The method of claim 6 further comprising using the weight factor to calculate a worst case total return BetaX as the ratio of the sum of the weighted worst case drawdowns of the first asset to the corresponding sum for the second asset over the duration of the holding times.

9. The method of claim 6 further comprising using the weight factor to calculate a percentile total return BetaX as the ratio of the sum of the weighted percentile drawdowns of the first asset to the corresponding sum for the second asset over the duration of the holding times.

10. An apparatus for comparing risk associated with a first financial asset with a second financial asset, comprising:
means for creating a risk-return profile for the first asset and a risk profile for the second asset over a defined time period having a plurality of asset holding times;
means for calculating an average negative total return for each of the first and second assets for each of the plurality of asset holding times;
means for calculating a worst case total return for the first and second assets for each of the plurality of asset holding times; and
means for calculating a percentile total return for the first and second assets for each of the plurality of asset holding times.

11. The apparatus of claim 10 further comprising means for defining a BetaX measure that defines how much more or less risky the first asset is relative to the second asset, and wherein a specific BetaX measure is associated with each of the average negative total return, the worst case total return, and the percentile total return, and wherein a drawdown comprises a total negative return for an asset.

12. The apparatus of claim 11 wherein an average negative total return BetaX is calculated as the ratio of the sum of the average drawdowns of the first asset to the corresponding sum for the second asset over the duration of the holding times.

13. The apparatus of claim 11 wherein a worst case total return BetaX is calculated as the ratio of the sum of the worst case drawdowns of the first asset to the corresponding sum for the second asset over the duration of the holding times.

14. The apparatus of claim 11 wherein a percentile total return BetaX is calculated as the ratio of the sum of the percentile drawdowns of the first asset to the corresponding sum for the second asset over the duration of the holding times.

15. The apparatus of claim 11 further comprising means for applying a weight factor for each holding time of the plurality of holding times, and wherein the weight factor is selected to be one of the following:
(1) a value of one if an associated value for that holding time from the risk-return profile is negative, and a value of zero if the associated value for that holding time from the risk-return profile is non-negative;
(2) the number of negative total returns for a respective holding time from the risk-return profile divided by the total number of total returns for that holding period from the risk return profile;
(3) the number of negative total returns for a respective holding time from the risk-return profile divided by the total number of negative total returns across all holding periods from the risk return profile; and
(4) a number that is a function of the risk-return profiles for both assets.

16. The apparatus of claim 15 wherein an average negative total return BetaX is calculated as the ratio of the sum of weighted average drawdowns of the first asset to the corresponding sum for the second asset over the duration of the holding times, using the weight factor for each holding time of the plurality of holding times.

17. The apparatus of claim 15 wherein a worst case total return BetaX is calculated as the ratio of the sum of the of weighted worst case drawdowns of the first asset to the corresponding sum for the second asset over the duration of the holding times, using the weight factor for each holding time of the plurality of holding times.

18. The apparatus of claim 15 wherein a percentile total return BetaX is calculated as the ratio of the sum of the of weighted percentile drawdowns of the first asset to the corresponding sum for the second asset over the duration of the holding times, using the weight factor for each holding time of the plurality of holding times.
